(19) United States
(12) Patent Application Publication
(10) Pub. No.: US 2024/0154453 A1
(43) Pub. Date: May 9, 2024

(54) POWER SUPPLY DEVICE

(71) Applicant: MIRAI-LABO KABUSHIKI KAISHA, Hachioji-shi (JP)

(72) Inventors: Toshio Hiratsuka, Hachioji-shi (JP); Raita Hiratsuka, Hachioji-shi (JP); Kenji Ito, Hachioji-shi (JP)

(73) Assignee: MIRAI-LABO KABUSHIKI KAISHA, Hachioji-shi (JP)

(21) Appl. No.: 18/279,304

(22) PCT Filed: Mar. 14, 2022
(86) PCT No.: PCT/JP2022/011451

§ 371 Date: Aug. 29, 2023

(30) Foreign Application Priority Data
Mar. 16, 2021 (JP) 2021-042980

(51) Int. Cl. H02J 7/35; H02J 3/38; H02J 7/00

(52) U.S. Cl. CPC H02J 7/35; H02J 3/38; H02J 7/00306; H02J 7/00309; H02J 7/0034; H02J 7/00712; H02J 7/007194; H02J 2300/26

(57) ABSTRACT

A power supply device includes a solar battery configured to generate electric power by light and output the electric power, a secondary battery cell configured to store the electric power, a battery management unit configured to perform a protection operation by cutting off the extraction of the electric power stored in the secondary battery cell when a storage voltage of the secondary battery cell is equal to or less than a protection voltage, and an automatic recovery control unit that is connected between the solar battery and the battery management unit and configured to perform a recovery charging operation by converting a portion of the electric power output from the solar battery into a first voltage and a first current value and supplying the electric power to the battery management unit even when the battery management unit is in an operation stop state.

### TECHNICAL FIELD

The present invention relates to a power supply device, and in particular to a power supply device for storing the output from a solar battery into a secondary battery cell.

### BACKGROUND ART

In recent years, solar batteries that generate power by the energy of solar light have become popular, and photovoltaic power generation by using a roof of a common dwelling home or unused land has become common. With such photovoltaic power generation facilities, electric power supply from a power plant via a power transmission network is used together in cases where the amount of power generated by solar light is insufficient. Further, surplus electric power is also sold through power transmission entities when electric power generated by solar light is greater than the electric power consumed.

However, in remote areas or underdeveloped areas where it is difficult to lay power transmission facilities, it is impossible to supply and sell electricity using the transmission network. This makes it difficult to install and utilize photovoltaic power generation facilities. Therefore, there is proposed an independent power supply device that combines a solar battery and a secondary battery, so that the electric power generated by the solar battery can be temporarily stored in the secondary battery and allow the electric power stored in the secondary battery to be extracted as required (e.g., see Patent Document 1).

FIG. 5 is a block diagram schematically illustrating a configuration of a conventionally proposed independent power supply device. As shown in FIG. 5, the conventional independent power supply device includes a solar battery 10, a charge/discharge control unit 20, a battery management unit (BMS: Battery Management System) 30, and a secondary battery cell 40. The output of the solar battery 10 is connected to the input of the charge/discharge control unit 20, and the output of the charge/discharge control unit 20 is connected to the battery management unit 30. The battery management unit 30 is connected to an electrode terminal of the secondary battery cell 40 and is driven by the electric power from the secondary battery cell 40 to obtain the state of the secondary battery cell 40 and control overcharge protection and overdischarge protection. The electric power stored in the secondary battery cell 40 is output to the load and charge/discharge control unit 20 via the battery management unit 30 and used to drive the load and the charge/discharge control unit 20.

With the independent power supply device of the conventional art, the charge/discharge control unit 20 and the battery management unit 30 are driven by the electric power extracted from the secondary battery cell 40, and the charge/discharge control unit 20 controls the charging operation and the discharging operation of the secondary battery cell 40. However, because the power from the secondary battery cell 40 to the charge/discharge control unit 20 cannot be supplied in a case where the overdischarge protection function of the battery management unit 30 operates when the remaining charge amount of the secondary battery cell 40 becomes low, there is a problem that the charge/discharge control unit 20 also stops operating and cannot resume the charging operation. Therefore, the present applicant proposed a technique for resuming the charging/discharging operation by starting the charge/discharge control unit 20 with the electric power supplied from the solar battery 10 even in a case where the overdischarge protection is being performed when the remaining charge amount of the secondary battery cell 40 becomes low (Patent Document 2). Further, in Patent Document 2, even if the secondary battery cell 40 is in an overdischarge state, the charge/discharge control unit 20 acquires the state of the secondary battery cell 40 from the battery management unit 30 and resumes charging by executing a pre-charge operation.

### RELATED ART DOCUMENTS

### Patent Documents

Patent Document 1: Japanese Laid-Open Patent Publication No. 2017-017778
Patent Document 2: Japanese Patent Publication No. 6031721

### SUMMARY OF THE INVENTION

### Problem to be Solved by the Invention

In the conventional art shown in Patent Document 2, a module having excellent replaceability and portability is used as a secondary battery. The secondary battery module can be replaced as needed. Thus, the secondary battery module being performed with the overdischarge protection is not expected to lead to further progression of discharge and reach a deep discharge state. Further, even if the secondary battery module reaches the deep discharge state, the charging and discharging operation can be easily continued and the secondary battery module being in the deep discharge state can be easily retrieved by replacing it with another secondary battery module.

However, with the independent power supply device installed in the above-described remote location, it is difficult to repeat the maintenance of facilities in a short period. When shortage of sunlight continues for a long period during a rainy season or a snow season, an independent power supply device located in a remote area cannot continue to charge the secondary battery. As a result, with the secondary battery cell 40 being in an overdischarge state, the operation of the battery management unit 30 may cause the discharge to further progress and reach a deep discharge state. Because the battery management unit 30 operates with electric power supplied from the secondary battery cell 40, the battery management unit 30 becomes into a non-operating state and cannot resume charging with the secondary battery cell 40 being in a deep discharge state. With the secondary battery cell 40 being in the deep discharge state, the state of the secondary battery cell 40 cannot be obtained and the pre-charge operation also cannot be executed because the battery management unit 30 is in the non-operating state even by using the technique of Patent Document 2.

Thus, with the conventional art, the battery management unit 30 cannot be restarted even if sunlight recovers in the case where the remaining charge amount of the secondary battery cell 40 progresses to the deep discharge state. Accordingly, the charge/discharge control unit 20 cannot execute the pre-charge operation or the charging/discharging operation. This result in a problem in which the storing and supplying of electric power generated by the solar battery 10 cannot continue.

Therefore, the present invention is provided in view of the above-described conventional problem and aims to provide a power supply device that enables recovery to a normal charging and discharging operation by charging the secondary battery cell even in a state where the remaining charge amount of the secondary battery cell becomes low and operation of the BMS is stopped.

### Means for Solving the Problem

In order to solve the above-mentioned problems, the power supply device of the present invention is characterized by including a solar battery that generates electric power by light and outputs the electric power, a secondary battery cell configured to store the electric power, a battery management unit configured to perform a protection operation by cutting off the extraction of the electric power stored in the secondary battery cell when a storage voltage of the secondary battery cell is equal to or less than a protection voltage, and an automatic recovery control unit that is connected between the solar battery and the battery management unit and configured to perform a recovery charging operation by converting a portion of the electric power output from the solar battery into a first voltage and a first current value and supplying the electric power to the battery management unit even when the battery management unit is in an operation stop state.

With the power supply device of the present invention, even in a state where the remaining charge amount of the secondary battery cell becomes low and operation of the battery management unit (BMS) is stopped, the battery management unit can be recovered to a normal charging/discharging operation by gradually charging the secondary battery cell with the output of the solar battery until the secondary battery cell is charged to be equal to or greater than a protection voltage.

Further, according to one aspect of the present invention, the automatic recovery control unit is configured to continue the recovery charging operation even while the battery management unit is performing the protection operation.

Further, according to one aspect of the present invention, there is further included a charge/discharge control unit connected between the solar battery and the battery management unit and configured to convert the electric power output from the solar battery into a charging voltage and a charging current and supply the electric power to the battery management unit, wherein the charge/discharge control unit is operated by the electric power stored in the secondary battery cell.

Further, according to one aspect of the present invention, the automatic recovery control unit is configured to stop the recovery charging operation when the charging voltage reaches a predetermined maximum voltage.

Further, according to one aspect of the present invention, the charge/discharge control unit is configured to use maximum power point tracking control.

Further, according to one aspect of the present invention, the automatic recovery control unit includes a temperature measurement unit that acquires a temperature of the secondary battery cell as a cell temperature, wherein the recovery charging operation stops when a temperature rise of the cell temperature is equal to or higher than a predetermined protection temperature.

Further, according to one aspect of the present invention, the automatic recovery control unit includes a voltage adjustment unit configured to boost a portion of the electric power from the solar battery and output the electric power at the first voltage, and a constant current output unit configured to be driven by the output of the first voltage from the voltage adjustment unit and output the first current value, wherein the output of the constant current output unit is supplied to the battery management unit.

Further, according to one aspect of the present invention, a backflow prevention diode is connected between the constant current output unit and the battery management unit.

### Effects of the Invention

According to the present invention, it is possible to provide a power supply device that enables recovery to a normal charge/discharge operation by charging a secondary battery cell even when the remaining charge amount of the secondary battery cell becomes low and the operation of a BMS is stopped.

### BRIEF DESCRIPTION OF THE DRAWINGS

FIG. 1 is a block diagram illustrating a power supply device 100 according to the first embodiment.

FIG. 2 is a circuit diagram illustrating an example of an automatic recovery control unit 50.

FIG. 3 is a timing chart illustrating an operation of a power supply device 100. FIG. 3(a) illustrates the output of an automatic recovery control unit 50. FIG. 3(b) illustrates a storage voltage of a secondary battery cell 40. FIG. 3(c) illustrates an operating state of a battery management unit 30. FIG. 3(d) illustrates a charging voltage of a charge/discharge control unit 20.

FIG. 4 is a flowchart illustrating an operation of the automatic recovery control unit 50 illustrated in FIG. 2.

FIG. 5 is a block diagram schematically illustrating a configuration of a conventionally proposed independent power supply device.

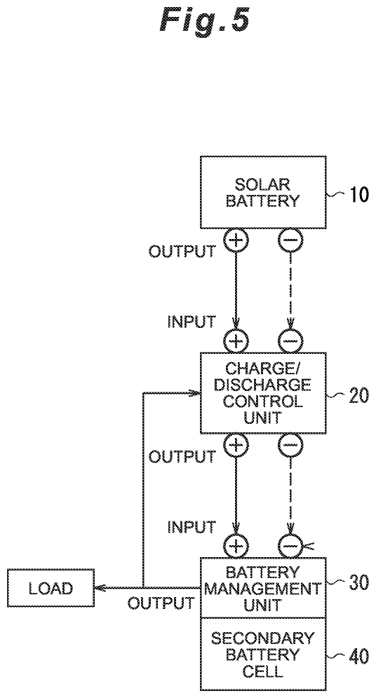

### MODES FOR CARRYING OUT THE INVENTION

### First Embodiment

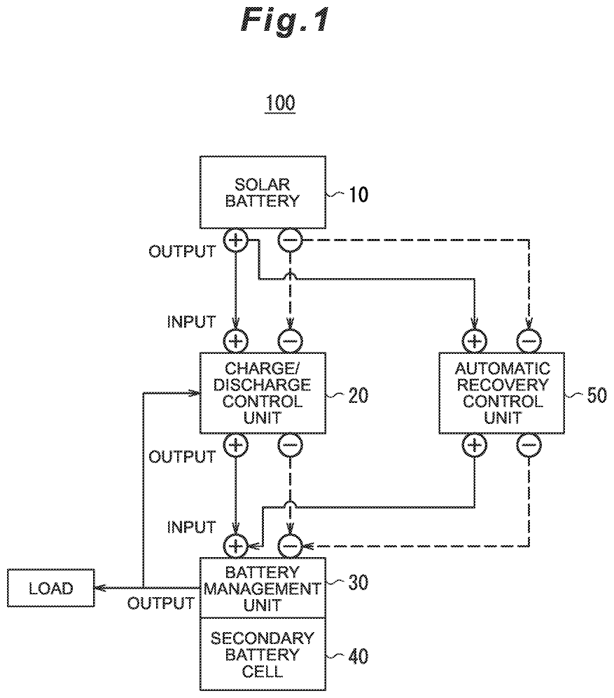

Hereinafter, embodiments of the present invention will be described in detail with reference to the drawings. Identical or equivalent components, members, and processes shown in the drawings shall be denoted by the same reference numerals, and redundant description thereof shall be omitted as appropriate. FIG. 1 is a block diagram schematically showing the configuration of a power supply device 100 according to this embodiment. As shown in FIG. 1, the power supply device 100 of this embodiment includes a solar battery 10, a charge/discharge control unit 20, a battery management unit (BMS: Battery Management System) 30, a secondary battery cell 40, and an automatic recovery control unit 50.

The solar battery 10 is a photoelectric conversion device that generates electric power by light and outputs the electric power. The configuration of the solar battery 10 is not to be limited, and a compound-semiconductor solar cell or the like such as a single-crystal silicon, a polycrystalline silicon, an amorphous silicon, a dye-sensitized silicon, or a CIGS based cell may be alternatively used. Further, it may have a shape to be placed on a frame or a shape to be laid on the surface of a road or a wall. The output of the solar battery 10 is electrically connected to the input of the charge/discharge control unit 20, and the electric power generated by the solar battery 10 is input to the charge/discharge control unit 20.

The charge/discharge control unit 20 is electrically connected between the solar battery 10 and the battery management unit 30 and serves as a portion for converting the electric power output from the solar battery 10 into a charging voltage and a charging current and supplying the electric power to the battery management unit 30. The charge/discharge control unit 20 is constituted by, for example, electronic circuitry including an IC (Integrated Circuit) and is operated by electric power stored in the secondary battery cell 40. The specific operation of the charge/discharge control unit 20 is not to be limited, and a pulse-width-modulation (PWM: Pulse Width Modulation) method or a maximum power point tracking control (MPPT: Maximum Power Point Tracking) method may be alternatively used. In order to efficiently store the electric power generated by the solar battery 10 in the secondary battery cell 40, it is preferable to use a maximum power point tracking control system.

The battery management unit 30 is electrically connected to an electrode terminal of the secondary battery cell 40 and serves as a portion for managing, for example, the acquisition of the state of the secondary battery cell 40, the protection of overdischarge of the secondary battery cell 40, and the protection of overcharge of the secondary battery cell 40. The battery management unit 30 is constituted by, for example, electronic circuitry including an IC and is operated by the electric power stored in the secondary battery cell 40. When the storage voltage of the secondary battery cell 40 is equal to or less than the protection voltage, the battery management unit 30 performs an overdischarge protection operation by cutting off the extraction of the power stored in the secondary battery cell 40. Further, when the storage voltage of the secondary battery cell 40 is equal to or greater than a predetermined value, the battery management unit 30 performs an overcharge protection operation by cutting off the charging operation to the secondary battery cell 40. The specific operation of the battery management unit 30 is not to be limited, and a known battery management system (BMS) may be alternatively used.

The secondary battery cell 40 serves as a portion for storing the electric power supplied from the charge/discharge control unit 20 and the automatic recovery control unit 50 by way of the battery management unit 30 and having the stored electric power extracted and supplied to the load and the charge/discharge control unit 20 by way of the battery management unit 30. The specific configuration of the secondary battery cell 40 is not to be limited, and a lithium ion battery, a nickel-metal hydride battery, a nickel-cadmium battery, an all-solid-state battery, or the like may be alternatively used. From the aspect of reusing resources, it is preferable to reuse the lithium ion battery that were used in an electric vehicle or a hybrid vehicle as the secondary battery cell 40.

The automatic recovery control unit 50 is connected in parallel with the charge/discharge control unit 20 between the solar battery 10 and the battery management unit 30 and serves as a portion for converting a part of the power output from the solar battery 10 and supplying the power to the battery management unit 30. As will be described in detail below, even when the battery management unit 30 is in an operation stopped state (non-operating state), the automatic recovery control unit 50 performs a recovery charging operation on the secondary battery cell 40 until operation of the battery management unit 30 is resumed by supplying a current to the battery management unit 30 and the secondary battery cell 40 at a first voltage and a first current value even if the battery management unit 30 is in an operation stopped state (non-operating state). Further, the automatic recovery control unit 50 continues the recovery charging operation even during the protection operation where the battery management unit 30 has cut off the power extraction from the secondary battery cell 40 being in an overdischarge state. Further, the automatic recovery control unit 50 stops the recovery charging operation when the charging voltage of the charge/discharge control unit 20 reaches a predetermined maximum voltage.

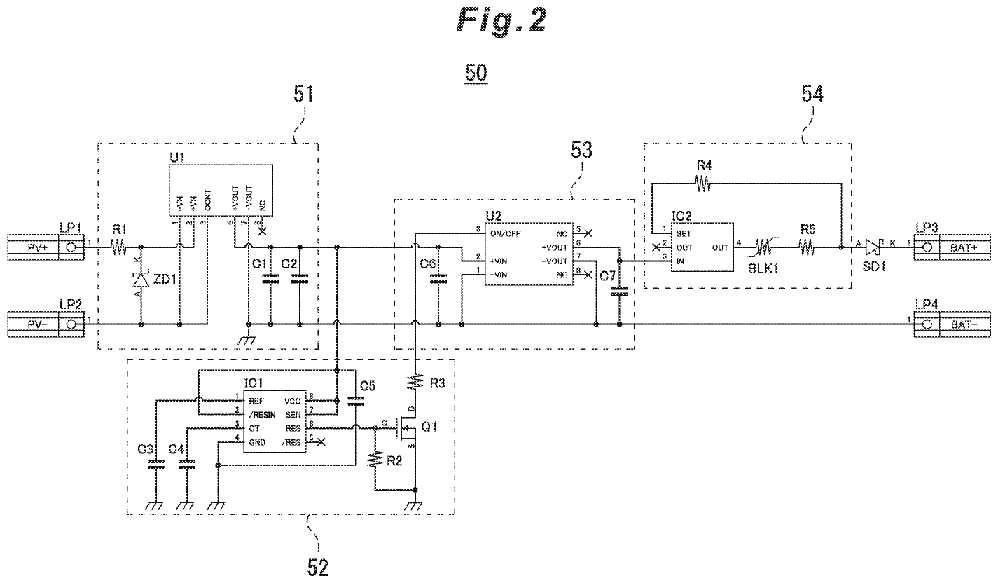

FIG. 2 is a circuit diagram showing an example of the automatic recovery control unit 50. As shown in FIG. 2, the automatic recovery control unit 50 includes a first buck-boost unit 51, a boost confirmation unit 52, a second boost unit 53, and a constant current output unit 54. According to this embodiment, the combination of the first buck-boost unit 51, the boost confirmation unit 52, and the second boost unit 53 corresponds to a voltage adjustment unit according to an embodiment of the present invention because it adjusts and outputs the voltage from the solar battery 10.

The first buck-boost unit 51 is a circuit for adjusting the electric power input from the input terminal LP1, LP2 to a predetermined scheduled voltage by boosting or stepping down the input electric power and outputting the adjusted electric power. Because the output voltage of the solar battery 10 changes from approximately 5 V to approximately 40 V, the operation of the below-described constant current output unit 54 is stabilized by adjusting the output voltage to a scheduled voltage (e.g., 12 V). In the example shown in FIG. 2, the first buck-boost unit 51 includes a resistor R1, a Zener diode ZD1, a DC-DC converter U1, and capacitors C1, C2. In the first buck-boost unit 51, the output of approximately a few voltages (V) from the solar battery 10 is boosted to, for example, 12 V and output to the second boost unit 53.

It is preferable to use an insulated type as the DC-DC converter U1, so that the effect on the inside of the automatic recovery control unit 50 can be reduced when a large voltage-change or current-change occurs in the solar battery 10 connected to the input terminals LP1, LP2. By using an insulating type as the DC-DC converter U1 and having the Zener diode ZD1 connected between the input terminal LP1 and LP2, electric current is short-circuited by way of the Zener diode ZD1 in a case where an excessive voltage difference occurs on the solar battery 10 side. Thereby, adverse effects on the circuitry disposed on the downstream side of the DC-DC converter U1 can be suppressed.

The boost confirmation unit 52 is a circuit that monitors the output voltage of the first buck-boost unit 51 and operates the second boost unit 53 when the output voltage reaches a predetermined voltage (12 V in the above-described example). In the embodiment shown in FIG. 2, the boost confirmation unit 52 includes capacitors C3, C4, C5, a control chip IC1, resistors R2, R3, and a transistor Q1. In this embodiment, because the boost confirmation unit 52 confirms the output voltage of the first buck-boost unit 51, the second boost unit 53 does not execute a boosting operation and the below-described output from the constant current output unit 54 is also stopped if the boost of the first buck-boost unit 51 is confirmed to still be in a stage where it is insufficient and has not reached a target output voltage. Thereby, stable current output can continue by driving the second boost unit 53 and the constant current output unit 54 in a stable state.

The second boost unit 53 is a circuit for further boosting the output from the first buck-boost unit 51 and outputting it to the constant current output unit 54. In the embodiment shown in FIG. 2, the second boost unit 53 includes capacitors C6, C7 and a DC-DC converter U2. The DC-DC converter U2, which is controlled to be driven on and off by a control signal from the boost confirmation unit 52, boosts an input voltage to a predetermined magnification and outputs the boosted voltage. For example, in a case where the output of DC-DC converter U1 is 12 V and the magnification is double, the DC-DC converter U2 outputs 24 V.

The constant current output unit 54 is a circuit that operates by the voltage output from DC-DC converter U2 and outputs a constant current from the output terminals LP3, LP4 to the battery management unit 30. In the embodiment shown in FIG. 2, the constant current output unit 54 includes a control chip IC2, resistors R4, R5, and a variable resistor BLK1. In the embodiment shown in FIG. 2, the backflow prevention diode SD1 is connected between the constant current output unit 54 and the output terminal LP3. As an example, when the output from DC-DC converter U2 is 24 V (first voltage), the constant current output unit 54 outputs a constant current of 70 mA (first current value).

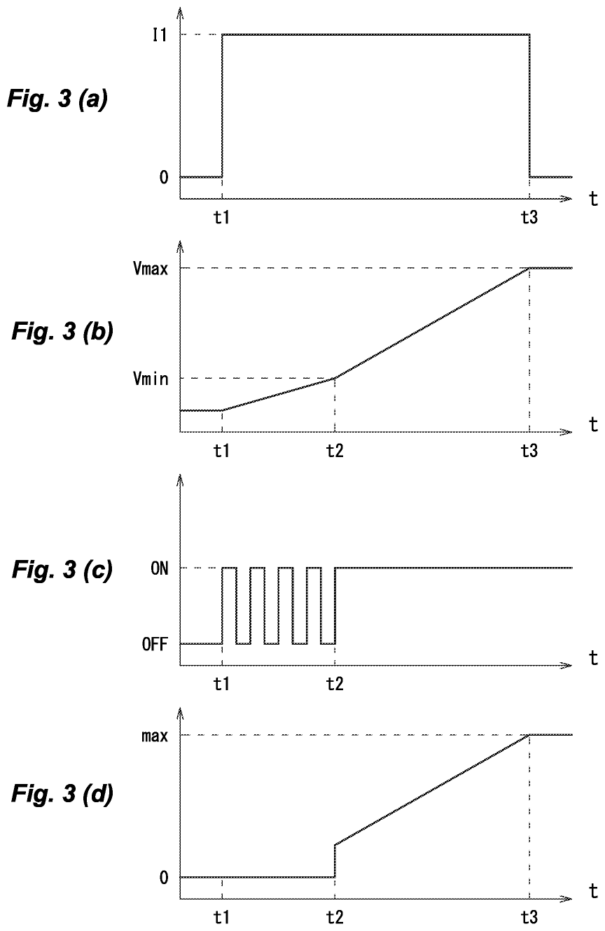

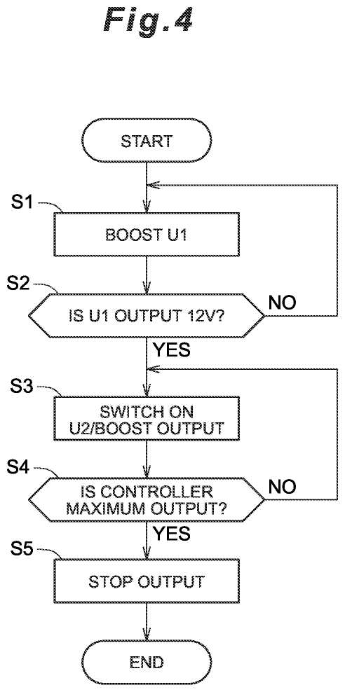

Next, the operation of the power supply device 100 according to this embodiment will be described with reference to FIGS. 3 and 4. FIG. 3 is a timing chart showing the operation of the power supply device 100. FIG. 3 (a) shows the output of the automatic recovery control unit 50. FIG. 3 (b) shows the storage voltage of the secondary battery cell 40. FIG. 3 (c) shows the operating state of the battery management unit 30. FIG. 3 (d) shows the charging voltage of the charge/discharge control unit 20. FIG. 4 is a flowchart showing the operation of the automatic recovery control unit 50 shown in FIG. 2. FIGS. 3 and 4 assumes a situation in which sunlight to the solar battery 10 is obtained in a case where a shortage of sunlight had continued for a long period such that the charge state of the secondary battery cell 40 has progressed to a deep discharge state and the battery management unit 30 has become into a non-operating state.

The horizontal axis of FIGS. 3(a) to 3(d) illustrates a common time axis that has “0” as the time in which sunlight to the solar battery 10 is obtained. The vertical axis of FIG. 3 (a) illustrates the current value supplied to the battery management unit 30 from the automatic recovery control unit 50. The vertical axis of FIG. 3 (b) illustrates the storage voltage of the secondary battery cell 40, “V min” indicates the protection voltage that causes the battery management unit 30 to perform the overdischarge protection operation, “V max” indicates the voltage that causes the battery management unit 30 to perform the overcharge protection operation. The vertical axis of FIG. 3 (c) illustrates the operating state of the battery management unit 30 in which “OFF” is the non-operating state and “ON” is the operating state. The vertical axis of FIG. 3(d) illustrates the charging voltage that the charge/discharge control unit 20 outputs to the battery management unit 30, and “max” indicates the maximum charging voltage that is set by the charge/discharge control unit 20.

In FIG. 3, the period from time “t=0” to “t=t1” is the voltage adjustment preparation period. In the voltage adjustment preparation period as shown in FIGS. 3 (a) to 3 (d), the output current of the automatic recovery control unit 50 is 0. Further, the storage voltage of the secondary battery cell 40 is in a deep discharge state. Further, the battery management unit 30 is in a non-operating state. Further, the charge/discharge control unit 20 is non-operating and its output is also 0.

The period from time “t=t1” to “t=t2” is the automatic recovery period. In the automatic recovery period as shown in FIGS. 3 (a) to 3 (d), the output current of the automatic recovery control unit 50 is “I1”. Further, the storage voltage of the secondary battery cell 40 gradually rises from the deep discharge state to the overdischarge protection voltage Vmin. Further, the battery management unit 30 is repeating the non-operating state and the operating state. Further, the charge/discharge control unit 20 is non-operating and its output is also 0.

The period from time “t=t2” to “t=t3” is the normal charge period. In the normal charge period as shown in FIGS. 3 (a) to 3 (d), the output current of the automatic recovery control unit 50 is “I1”. Further, the storage voltage of the secondary battery cell 40 is higher than the overdischarge protection voltage Vmin. Further, the battery management unit 30 is in the operating state. Further, the charge/discharge control unit 20 is operating and supplying the output of the solar battery 10 to the secondary battery cell 40 at the charging voltage. Here, in FIG. 3 (b) and FIG. 3 (d), the change in the graph of the normal charging period shows a constant increase rate as an example. However, because the electric power generated by the solar battery 10 is supplied as a charging voltage by the charge/discharge control unit 20, the increase rate or increase/decrease may not always be constant.

The automatic recovery end period is from time “t=t3” and after. When the charging voltage output by the charge/discharge control unit 20 reaches “max”, the output current of the automatic recovery control unit 50 becomes 0.

When the automatic recovery operation starts as shown in FIG. 4, the automatic recovery control unit 50 adjusts the output from the solar battery 10 to a predetermined scheduled voltage as a preliminary adjustment operation in Step S1. In the embodiment of the circuit shown in FIG. 2, the preliminary adjustment operation is executed by the DC-DC converter U1 of the first buck-boost unit 51 and continued during a period in which the electric power from the solar battery 10 is supplied even after Step S2.

Step S2 is the boost confirmation operation in which it is confirmed whether the result of the preliminary adjustment operation has been adjusted to the scheduled voltage. In the embodiment of the circuitry shown in FIG. 2, the boost confirmation operation is executed by the control chip IC1 that sends a control signal to the DC-DC converter U2. As a specific example, the boost confirmation unit 52 monitors the output from the first buck-boost unit 51 and confirms whether the output of the DC-DC converter U1 is adjusted to a predetermined voltage value (scheduled voltage, for example, 12 V). If the output of the DC-DC converter U1 has not reached the scheduled voltage, the boost confirmation unit 52 sends an OFF signal to repeat the preliminary adjustment operation of Step S1. If it has been reached, an ON signal is sent to shift to Step S3.

Step S3 is a boost output operation that further boosts the voltage adjusted to the scheduled voltage in the preliminary adjustment operation and outputs a constant current at the first current value. In the embodiment of the circuit shown in FIG. 2, the boost output operation is executed by the DC-DC converter U2 of the second boost unit 53 and the control chip IC2. As a specific example, when the boost confirmation unit 52 sends an ON signal as a control signal to the DC-DC converter U2, the DC-DC converter U2 performs a boost operation that boosts the scheduled voltage (12 V) to the first voltage (24 V). The constant current output unit 54 is driven by the first voltage boosted by the second boosting unit 53 and outputs the first current value.

In the embodiment of the circuit shown in FIG. 2, the boost confirmation unit 52 sends an OFF signal to the DC-DC converter U2 if the output of the DC-DC converter U1 is not the scheduled voltage (12 V) in Steps S2 and S3. Accordingly, the DC-DC converter U2 does not perform the boost operation and its output is 0 mA and 0 V. When the output of the DC-DC converter U2 reaches the scheduled voltage, the boost confirmation unit 52 sends an ON signal to the DC-DC converter U2, and the DC-DC converter U2 performs the boost operation and outputs a first current value (70 mA) with the first voltage (24V).

In the voltage adjustment preparation period from “t=0” to “t=t1” in FIG. 3 (a), the adjustment to the scheduled voltage is not achieved by the first buck-boost unit 51. Therefore, the boost by the second boost unit 53 and the output of electric current by the constant current output unit 54 are not executed, and the output current is 0. When the time becomes “t=t1” and the adjustment to the scheduled voltage is confirmed by the boost confirmation unit 52, the boost by the second boost unit 53 and the output of electric current by the constant current output unit 54 are executed in which a constant current at the first current value (I1) is output from the output terminals LP3, LP4 to the battery management unit 30. Thereby, at the time “t=t1”, the constant current output from the automatic recovery control unit 50 is quickly changed from 0 to the first current value, and output of a stable constant current can be performed. In addition, the output of the solar battery 10 is not directly supplied to the battery management unit 30.

In the automatic recovery period from “t=t1” to “t=t2” in FIG. 3, the recovery charging operation is continued by supplying the first voltage and the automatic recovery current of the first current from the automatic recovery control unit 50 to the battery management unit 30. Although the battery management unit 30 is in a non-operating state when the secondary battery cell 30 is in the deep discharge state, it temporarily becomes an operating state when the automatic recovery current is supplied. At this time, although the battery management unit 30 executes management of the secondary battery cell 30, it shifts to the non-operating state again because the storage voltage is less than the overdischarge protective voltage Vmin and the secondary battery cell 30 is in the deep discharge state. However, even during the period where the battery management unit 30 temporarily recovers to the operating state, (although for a short period) the automatic recovery current is supplied to the secondary battery cell 40 in the charging direction and the storage voltage is slightly increased by the recovery charging operation.

In the automatic recovery period, the automatic recovery control unit 50 continues to supply the automatic recovery current to the battery management unit 30. Accordingly, the non-operation of the battery management unit 30 and the temporary recovery of the battery management unit 30 are repeated. During these repetitions, the charging for a short period and the slight increasing of the storage voltage are repeated by the recovery charging operation. When the storage voltage of the secondary battery cell 40 reaches the overdischarge protection voltage Vmin at the time “t=t2”, it becomes possible for the battery management unit 30 to allow electric power to be extracted from the secondary battery cell 40 and continue the operating state.

After the time “t=t2”, the storage voltage of the secondary battery cell 40 becomes larger than the overdischarge protection voltage Vmin, and the battery management unit 30 allows the electric power extraction from the secondary battery cell 40. Accordingly, the battery management unit 30 and the charge/discharge control unit 20 are operated by the output of the secondary battery cell 40, and it is possible to continue the charging of the secondary battery cell 40 with the electric power from the solar battery 10 and the supplying of electric power from the secondary battery cell 40 to the load.

Step S4 is the maximum output check operation in which the operation proceeds to Step S3 if the charge voltage output by the charge/discharge control unit 20 has not reached the maximum voltage max and proceeds to Step S5 if it has been reached. Because the output of the charge/discharge control unit 20 and the output of the automatic recovery control unit 50 are both connected to the battery management unit 30 as shown in FIG. 1, the automatic recovery control unit 50 can obtain the charging voltage output from the charge/discharge control unit 20 by monitoring the voltage applied to the output terminals LP3,LP4 of the automatic recovery control unit 50.

Step S5 is an output stop operation in which the automatic recovery control unit 50 stops supplying electric current to the battery management unit 30 at the first voltage and the first current value. In the embodiment of the circuit shown in FIG. 2, the constant current output unit 54 stops outputting a constant current when an electric voltage greater than the voltage set by the backflow prevention diode SD1 is applied to the output terminal portion LP3. As a specific example, the automatic recovery control unit 50 performs an output stop operation when the charging voltage of the charge/discharge control unit 20 is larger than the first voltage (24 V).

After the time “t=t3”, the current value output from the automatic recovery control unit 50 becomes 0 because the charging voltage can be supplied to the battery managing section 30 at the maximum voltage set by the charge/discharge control unit 20. Further, the storage voltage of the secondary battery cell 40 is managed by the battery management unit 30 and is controlled between the voltage Vmin of overdischarge protection and the voltage Vmax of overcharge protection. The charge/discharge control unit 20 is operated with the electric power supplied from the secondary battery cell 40 and charges the electric power generated by the solar cell 10 to the secondary battery cell 30 via the battery management unit 30.

With the power supply device 100 of this embodiment described above, the automatic recovery control unit 50 is connected between the solar battery 10 and the battery management unit 30 and performs the recovery charging operation, so that a part of the electric power output from the solar battery 10 is converted into the first voltage and the first current value and supplied to the battery management unit even when the battery management unit 30 is in the operation stop state. Accordingly, even when it is impossible for the battery management unit 30 to extract electric power or acquire information from the secondary battery cell 30 being in the deep discharge state, the recovery charging operation allows the secondary battery cell 40 to be gradually charged. Further, by suppressing the power consumed by the operation of the battery management unit 30, the recovery charging operation can be efficiently continued.

Further, the automatic recovery control unit 50 is connected in parallel with the charge/discharge control unit 20, so that electric power is not consumed in the automatic recovery control unit 50 during operation of the automatic recovery control unit 50. Thereby, the recovery charging operation can be efficiently continued and allow the secondary battery cell 40 to be gradually charged even when the output of the solar battery 10 is relatively small.

### Second Embodiment

Next, a second embodiment of the present invention will be described. Contents overlapping with the first embodiment will be omitted. In the first embodiment, the automatic recovery control unit 50 continues the recovery charging operation until the charging voltage output from the charge/discharge control unit 20 reaches the maximum voltage “max”. In this embodiment, the automatic recovery control unit 50 stops the recovery charging operation with the first voltage and the first current value when the secondary battery cell 40 is short-circuited.

In the present embodiment, the automatic recovery control unit 50 includes a temperature measurement unit that measures the temperature of the secondary battery cell 40 and acquires cell temperature information. Further, the automatic recovery control unit 50 records beforehand the permissible temperature rise of the secondary battery cell 40 as the protection temperature.

At the time “t=t1” in which the first current value starts to be output to the battery management unit 30, the automatic recovery control unit 50 measures the temperature of the secondary battery cell 40 with the temperature measurement unit and acquires the cell temperature information at the beginning of the recovery charging operation. Further, the automatic recovery control unit 50 continues to acquire the cell temperature information of the secondary battery cell 40 by the temperature measurement unit even while the recovery charging operation is continued and the first current value is being output to the battery management unit 30.

The automatic recovery control unit 50 calculates the temperature rise from the start of the recovery charging operation based on the acquired cell temperature information and stops the recovery charging operation when the temperature rise becomes greater than the protection temperature. This is because, if a failure such as a short circuit occurs inside the secondary battery cell 40, the electric power supplied by the recovery charging operation is not stored in the secondary battery cell 40 but is consumed inside the secondary battery cell 40 and causes the cell temperature to increase.

With the power supply device 100 of this embodiment described above, it is possible to protect the secondary battery cell 40 in which a failure has occurred by stopping the recovery charging operation with the automatic recovery control unit 50 when the temperature rise of the cell temperature reaches the protection temperature or higher.

The present invention is not limited to the above-described embodiments, and various changes can be made within the scope shown in the claims, and embodiments obtained by appropriately combining the technical means disclosed respectively in the different embodiments are also included in the technical scope of the present invention.

### DESCRIPTION OF THE REFERENCE NUMERALS

100 . . . power supply device
10 . . . solar battery
20 . . . charge/discharge control unit
30 . . . battery management unit
40 . . . secondary battery cell
50 . . . automatic recovery control unit
51 . . . first buck-boost unit
52 . . . boost confirmation unit
53 . . . second boost unit
54 . . . constant current output unit

1. A power supply device comprising:
a solar battery that generates electric power by light and outputs the electric power;
a secondary battery cell configured to store the electric power;
a battery management unit configured to perform a protection operation by cutting off the extraction of the electric power stored in the secondary battery cell when a storage voltage of the secondary battery cell is equal to or less than a protection voltage; and
an automatic recovery control unit that is connected between the solar battery and the battery management unit and configured to perform a recovery charging operation by converting a portion of the electric power output from the solar battery into a first voltage and a first current value and supplying the electric power to the battery management unit even when the battery management unit is in an operation stop state.

2. The power supply device according to claim 1, wherein the automatic recovery control unit is configured to continue the recovery charging operation even while the battery management unit is performing the protection operation.

3. The power supply device according to claim 1, further comprising: a charge/discharge control unit connected between the solar battery and the battery management unit and configured to convert the electric power output from the solar battery into a charging voltage and a charging current and supply the electric power to the battery management unit,
wherein the charge/discharge control unit is operated by the electric power stored in the secondary battery cell.

4. The power supply device according to claim 3, wherein the automatic recovery control unit is configured to stop the recovery charging operation when the charging voltage reaches a predetermined maximum voltage.

5. The power supply device according to claim 3, wherein the charge/discharge control unit is configured to use maximum power point tracking control.

6. The power supply device according to claim 1, wherein the automatic recovery control unit includes a temperature measurement unit that acquires a temperature of the secondary battery cell as a cell temperature,
wherein the recovery charging operation stops when a temperature rise of the cell temperature is equal to or higher than a predetermined protection temperature.

7. The power supply device according to claim 1, wherein the automatic recovery control unit includes:
a voltage adjustment unit configured to boost a portion of the electric power from the solar battery and output the electric power at the first voltage, and
a constant current output unit configured to be driven by the output of the first voltage from the voltage adjustment unit and output the first current value,
wherein the output of the constant current output unit is supplied to the battery management unit.

8. The power supply device according to claim 7, wherein a backflow prevention diode is connected between the constant current output unit and the battery management unit.

9. The power supply device according to claim 2, further comprising: a charge/discharge control unit connected between the solar battery and the battery management unit and configured to convert the electric power output from the solar battery into a charging voltage and a charging current and supply the electric power to the battery management unit,
wherein the charge/discharge control unit is operated by the electric power stored in the secondary battery cell.

10. The power supply device according to claim 9, wherein the automatic recovery control unit is configured to stop the recovery charging operation when the charging voltage reaches a predetermined maximum voltage.

11. The power supply device according to claim 4, wherein the charge/discharge control unit is configured to use maximum power point tracking control.

12. The power supply device according to claim 10, wherein the charge/discharge control unit is configured to use maximum power point tracking control.

13. The power supply device according to claim 2, wherein the automatic recovery control unit includes a temperature measurement unit that acquires a temperature of the secondary battery cell as a cell temperature,
wherein the recovery charging operation stops when a temperature rise of the cell temperature is equal to or higher than a predetermined protection temperature.

14. The power supply device according to claim 3, wherein the automatic recovery control unit includes a temperature measurement unit that acquires a temperature of the secondary battery cell as a cell temperature,
wherein the recovery charging operation stops when a temperature rise of the cell temperature is equal to or higher than a predetermined protection temperature.

15. The power supply device according to claim 4, wherein the automatic recovery control unit includes a temperature measurement unit that acquires a temperature of the secondary battery cell as a cell temperature,
wherein the recovery charging operation stops when a temperature rise of the cell temperature is equal to or higher than a predetermined protection temperature.

16. The power supply device according to claim 5, wherein the automatic recovery control unit includes a temperature measurement unit that acquires a temperature of the secondary battery cell as a cell temperature,
wherein the recovery charging operation stops when a temperature rise of the cell temperature is equal to or higher than a predetermined protection temperature.

17. The power supply device according to claim 2, wherein the automatic recovery control unit includes:
a voltage adjustment unit configured to boost a portion of the electric power from the solar battery and output the electric power at the first voltage, and
a constant current output unit configured to be driven by the output of the first voltage from the voltage adjustment unit and output the first current value,
wherein the output of the constant current output unit is supplied to the battery management unit.

18. The power supply device according to claim 3, wherein the automatic recovery control unit includes:
a voltage adjustment unit configured to boost a portion of the electric power from the solar battery and output the electric power at the first voltage, and
a constant current output unit configured to be driven by the output of the first voltage from the voltage adjustment unit and output the first current value,
wherein the output of the constant current output unit is supplied to the battery management unit.

19. The power supply device according to claim 4, wherein the automatic recovery control unit includes:
a voltage adjustment unit configured to boost a portion of the electric power from the solar battery and output the electric power at the first voltage, and
a constant current output unit configured to be driven by the output of the first voltage from the voltage adjustment unit and output the first current value,
wherein the output of the constant current output unit is supplied to the battery management unit.

20. The power supply device according to claim 5, wherein the automatic recovery control unit includes:
a voltage adjustment unit configured to boost a portion of the electric power from the solar battery and output the electric power at the first voltage, and
a constant current output unit configured to be driven by the output of the first voltage from the voltage adjustment unit and output the first current value,
wherein the output of the constant current output unit is supplied to the battery management unit.
